(19) United States
(12) Patent Application Publication
(10) Pub. No.: US 2008/0147288 A1
(43) Pub. Date: Jun. 19, 2008

(54) Method and Control Unit for Protecting a Clutch in a Drivetrain of a Motor Vehicle

(75) Inventors: Marcus Reiher, Greiz (DE); Peter Baur, Moensheim (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/955,509

(22) Filed: Dec. 13, 2007

(30) Foreign Application Priority Data
Dec. 13, 2006 (DE) 102006058724.3-26

(51) Int. Cl. G06F 7/00

(52) U.S. Cl. 701/84

(57) ABSTRACT

A method controls an internal combustion engine in a drivetrain of a motor vehicle. The drivetrain has a variable-speed transmission and a friction clutch which is to be actuated by the driver. By use of the friction clutch a force-fitting action between the internal combustion engine and the variable-speed transmission is controlled, with it being possible for the clutch torque of the internal combustion engine to be reduced in order to protect the clutch from thermal overloading. A temperature of the clutch is determined, a limit value which is dependent on the determined temperature is determined and a rotational speed difference across the clutch is determined. The clutch torque is reduced if the rotational speed difference approaches or reaches or exceeds the temperature-dependent predetermined limit value. A control unit is set up to carry out a method of this type or to control its process.

### CROSS-REFERENCE TO RELATED APPLICATION

This application claims the priority, under 35 U.S.C. § 119, of German application DE 10 2006 058 724.3-26, filed Dec. 13, 2006; the prior application is herewith incorporated by reference in its entirety.

### BACKGROUND OF THE INVENTION

### Field of the Invention

The present invention relates to a method for controlling an internal combustion engine in a drivetrain of a motor vehicle, which drivetrain has a variable-speed transmission and a friction clutch which is to be actuated by the driver. By use of the friction clutch, a force-fitting action between the internal combustion engine and the variable-speed transmission is controlled, with it being possible for the clutch torque of the internal combustion engine to be reduced in order to protect the clutch from thermal overloading. The invention also relates to a control unit which is set up to control an internal combustion engine in a drivetrain of a motor vehicle. The drivetrain has a variable-speed transmission and a friction clutch which is to be actuated by the driver. By use of the friction clutch, a force-fitting action between the internal combustion engine and the variable-speed transmission is controlled, and the control unit is set up to reduce the clutch torque of the internal combustion engine in order to protect the clutch from thermal overloading.

Here, clutch torque is to be understood to mean the torque provided by the internal combustion engine to the clutch. The clutch torque is given by the torque which results from the combustion in combustion chambers of the internal combustion engine, by subtracting losses which result from the charge exchange, friction, and the drive of auxiliary units.

A method of this type and a control unit of this type are known in each case from published, non-prosecuted German patent application DE 10 2005 026 469 A1. The known subject matter involves the protection of a new clutch during a check of the vehicle at the end of a production process. Without a protective function of this type, according to DE 10 2005 026 469 A1, in the event of fast vehicle movements between an assembly line and a test stand, there is the risk of thermal overloading of the clutch. The risk is substantiated in DE 10 2005 026 469 in that, in a situation of this type, clutch-specific parameters such as the biting point of the clutch have not yet been taught in. To remedy this, the torque which can be generated by the internal combustion engine is restricted to a maximum permissible value by interventions into the engine controller in the new state.

Modern engine controllers coordinate all torque demands at the internal combustion engine consistently on one torque level, that is to say on the basis of torque demands and influences of actuating variables on the actual torque. Here, a theoretically optimum indicated torque of the internal combustion engine is formed inter alia from present values of the cylinder charge, the air ratio lambda, the ignition angle and the rotational speed. This is known for example from the publication titled “Ottomotor-Management: Motronic Systeme” [“Spark-ignition Engine Management Motronic systems”], Robert Bosch GmbH, first edition, April 2003, page 41, under the heading “Momentenmodell Drehmoment (Torque Modeling)”. The actuating intervention efficiencies used in the actuating variable calculation and output give a value of the indicated actual torque, and this, taking into consideration the losses, gives a value of the actual clutch torque.

Thermal overloading of the clutch can occur not only in the described situation at the end of the production process. Further critical situations are stop-and-go operation, operation of the motor vehicle as a towing vehicle, starting the motor vehicle on a slope or stopping the motor vehicle on a slope with a slipping clutch, and a brief, incomplete opening of the clutch during a demand for full torque for maximum vehicle acceleration during driving, for example before an overtaking process. These situations are critical in particular in high-power and heavy motor vehicles such as SUVs, since the high normal force here prevents slip of the drive wheels, which leads to increased slip at the clutch.

In principle, the known limitation of the maximum torque could also be used to protect the clutch in these situations. However, these situations differ from the situation at the end of a production process as specified in the introduction in that the vehicle is in the hands of a customer, who has generally intentionally chosen a high-power vehicle and therefore only unwillingly accepts restrictions in the engine power and/or torque.

### BRIEF SUMMARY OF THE INVENTION

It is accordingly an object of the invention to provide a method and a control unit for protecting a clutch in a drivetrain of a motor vehicle that overcomes the above-mentioned disadvantages of the prior art methods and devices of this general type, by which the most reliable protection of the clutch possible is given with the greatest possible acceptance of necessary interventions into the engine controller.

With the foregoing and other objects in view there is provided, in accordance with the invention, a method for controlling an internal combustion engine in a drivetrain of a motor vehicle. The drivetrain further has a variable-speed transmission and a friction clutch for actuation by a driver. The method contains the steps of controlling a force-fitting action between the internal combustion engine and the variable-speed transmission using the friction clutch, reducing a clutch torque of the internal combustion engine for protecting the friction clutch from thermal overloading, determining a temperature of the friction clutch, determining a limit value, being dependent on the temperature, of a rotational speed difference across the friction clutch, and reducing the clutch torque if the rotational speed difference one of approaches, reaches and exceeds the limit value.

The solution is therefore characterized in that a temperature of the clutch is determined, a threshold value, which is dependent on the determined temperature, of a rotational speed difference across the clutch is determined, and the clutch torque is reduced if the rotational speed difference exceeds the temperature-dependent predetermined threshold value.

In contrast to the known methods, there is therefore no reduction of the clutch torque to a fixed value. Instead, the rotational speed slip across the clutch is restricted to the threshold value which is determined in a temperature-dependent fashion. This can result in completely different values of the clutch torque.

A first advantage of the invention is that the clutch torque is reduced for the purpose of protecting the clutch not purely in a precautionary, and therefore in many cases unnecessary, fashion, but rather that a reduction takes place only when a thermal overload of the clutch is actually impending.

A further advantage results from the fact that interventions which take place according to the invention irritate the driver intuitively less than would be the case in the case of a restriction in clutch torque independently of the rotational speed difference. If, in contrast, the torque is limited without a limitation of the rotational speed difference, it is possible, with the same release of heat in the clutch, for a smaller torque value to be given at a relatively high rotational speed difference. The relatively high rotational speed difference is associated, assuming identical initial clutch rotational speeds, with a higher engine rotational speed, which leads the driver, who initially allows the clutch to slip, to expect a larger torque than is actually available when he closes the clutch. The driver intuitively assumes that the engine provides the optimum torque associated with the present rotational speed, which is however not the case on account of the limitation of the torque. This can therefore result overall in a power behavior which is irritating to the driver.

In the case of the invention, although the driver must also accept a power loss, the power loss is however in line with the perceived rotational speed level, and therefore does not lead to irritation. The invention therefore results in a clearer, intuitively perceptible feedback of reactions of the vehicle to a clutch actuation by the driver. The clutch is therefore protected effectively overall. Improved drivability is given here in comparison with other interventions. The improved drivability, together with the restriction in the interventions to actually necessary cases, ensures better acceptance of the clutch protective function by the driver.

In accordance with an added mode of the invention, there is step of determining the temperature of the friction clutch using a mathematical model from operating parameters of the drivetrain. The operating parameters include at least values of the clutch torque and of the rotational speed difference across the friction clutch.

In accordance with a further mode of the invention, there is the step of monitoring as to whether the friction clutch is actuated, and carrying out the method only if the friction clutch is actuated.

In accordance with another mode of the invention, there are the steps of limiting a permanent slip when the friction clutch is not actuated and determining the rotational speed difference from rotational speed values of an engine rotational speed sensor, of a transmission rotational speed sensor and/or of a wheel rotational speed sensor of the motor vehicle.

In accordance with a concomitant mode of the invention, there is the step of determining the rotational speed difference from rotational speed values of an engine rotational speed sensor and of a wheel rotational speed sensor of the motor vehicle.

It is self-evident that the features specified above and those yet to be explained below can be used not only in the combination specified in each case but also in other combinations or individually without departing from the scope of the present invention.

Other features which are considered as characteristic for the invention are set forth in the appended claims.

Although the invention is illustrated and described herein as embodied in a method and a control unit for protecting a clutch in a drivetrain of a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, illustration of a drivetrain of a motor vehicle; and

FIG. 2 is a diagrammatic illustration showing method aspects and device aspects of an exemplary embodiment according to the invention.

### DETAILED DESCRIPTION OF THE INVENTION

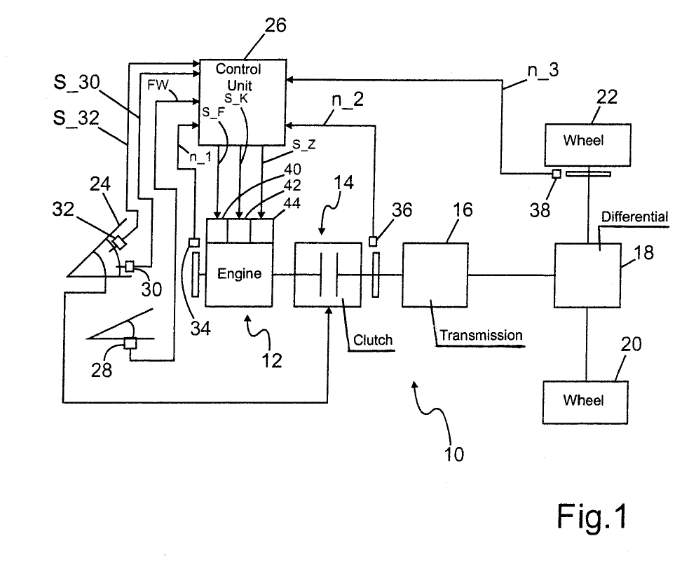

Referring now to the figures of the drawing in detail and first, particularly, to FIG. 1 thereof, there is shown a drivetrain 10 of a motor vehicle having an internal combustion engine 12, a clutch 14, a variable-speed transmission 16, a differential 18 and drive wheels 20, 22. The clutch 14 is a friction clutch which is actuated by the driver of the motor vehicle. Conventional friction clutches have at least one driver plate which is pressed by a spring-loaded pressure plate against a flywheel of the internal combustion engine 12. The driver plate is connected in an axially movable but rotationally fixed manner to a transmission input shaft. In the closed state of the clutch 14, the torque of the internal combustion engine 12 is, by a force-fitting action, transferred into the driver plate of the clutch 14 and transmitted from there to the transmission input shaft.

The actuation of the clutch 14 takes place counter to the spring loading. In this application, an actuation of the clutch by the driver of the motor vehicle is to be understood to mean that the actuating force required to overcome the spring loading is applied at least partially by the driver. In the embodiment of FIG. 1, a clutch pedal 24 serves for this purpose. The transmission of the pedal force to the clutch 14 generally takes place by a hydraulic system.

The internal combustion engine 12 is controlled by a control unit 26 which for this purpose processes signals which depict various operating parameters of the drivetrain 10. In the illustration of FIG. 1, these are primarily signals of a driver demand transducer 28 which measures a torque demand FW of the driver, measures a signal S_30 of a first clutch sensor 30 which measures an actuation of the clutch pedal 24, a signal S_32 of a second clutch sensor 32 which signals a non-actuated clutch pedal 24, a signal n_1 of a first rotational speed transducer 34 which measures an internal-combustion-engine-side first rotational speed n_1 of the clutch 14 (clutch input rotational speed), a signal n_2 of a second rotational speed transducer 36 which measures a variable-speed-transmission-side second rotational speed n_2 of the clutch 14 (clutch output rotational speed), and, alternatively or in addition to the second sensor 36, a signal n_3 of a wheel rotational speed sensor 38 which measures a rotational speed n_3 of a drive wheel of the motor vehicle.

Assuming that the control unit 26 knows the gear which is engaged in the variable-speed transmission 16, the control unit 26 can determine the rotational speed n_2 from the rotational speed n_3 and the present transmission ratio. The use of the wheel rotational speed sensor 38 which is provided in any case for anti-lock systems and/or driving dynamics regulating systems therefore has cost advantages which result from the possibility of dispensing with the second rotational speed sensor 36.

The clutch sensors 30, 32 are preferably realized not as end-position switches but rather deliver a signal change when the clutch pedal 24 passes predetermined pedal travel positions which lie between the end positions and delimit an actuating range in which the driver controls the torque transmission via the clutch 14 by use of the pedal 24. In one preferred embodiment, the control unit 26 generates an internal signal KB which indicates an actuation of the clutch 14 by the driver if the position of the clutch pedal 24 lies in the actuating range.

The first clutch sensor 30 signals, in one embodiment, a position at 80% of the pedal travel between a non-actuated and a fully-actuated pedal 24, while the second clutch sensor 32 changes its signal at approximately 5% of the maximum pedal travel. Other values are likewise possible. It is important in any case that the signals of the clutch sensors 30, 32 allow the control unit 26 to detect an actuation, which takes place between the pedal positions, of the pedal 24 by the driver.

It is self-evident that modern drivetrains 10 are provided with a plurality of further sensors which are not illustrated here for reasons of clarity. Examples of such sensors are air mass sensors, temperature sensors, pressure sensors etc. The listing of the sensors 28 to 38 is therefore not meant to be exhaustive.

It is also not necessary for a separate sensor to be provided for each operating parameter which is processed by the control unit 26, because the control unit 26 can model various operating parameters by use of mathematical models from other, measured operating parameters.

This applies in particular to a clutch temperature TK which, in one embodiment, is modeled by the control unit 26 from a temperature of the internal combustion engine 12 and/or of the variable-speed transmission 16 as a base value and a heat energy input which is determined from the clutch torque and the rotational speed difference across the clutch 14.

From the received sensor signals, the control unit 26 forms inter alia actuating variables for setting the torque which is to be generated by the internal combustion engine 12.

The control unit 26 is also set up, in particular programmed, to carry out the method according to the invention or one of its embodiments and/or to control the corresponding method process.

As actuating members, the internal combustion engine 12 conventionally has subsystems 40, 42, 44, of which one subsystem 40 serves for controlling the charge of combustion chambers, one subsystem 42 serves for controlling the mixture formation, and one subsystem 44 serves for controlling the ignition of the combustion chamber charges. The subsystem 40 for controlling the charges has, in one embodiment, an electronically controlled throttle flap for controlling the air supply to the internal combustion engine 12, which throttle flap is activated with an actuating signal S_F. The subsystem 42 for controlling the mixture formation has, in one embodiment, an arrangement of injectors, via which fuel is metered into an intake pipe or into individual combustion chambers of the internal combustion engine 12 by actuating signals S_K. Actuating signals S_Z serve for triggering injections in the combustion chambers.

The torque generated by the internal combustion engine 12 can be reduced in particular by restricting the combustion chamber charges and/or by shutting off the fuel supply to one or more combustion chambers and/or by delaying the triggering of ignitions with respect to an ignition time at which an optimum torque would be generated (retarding the ignition).

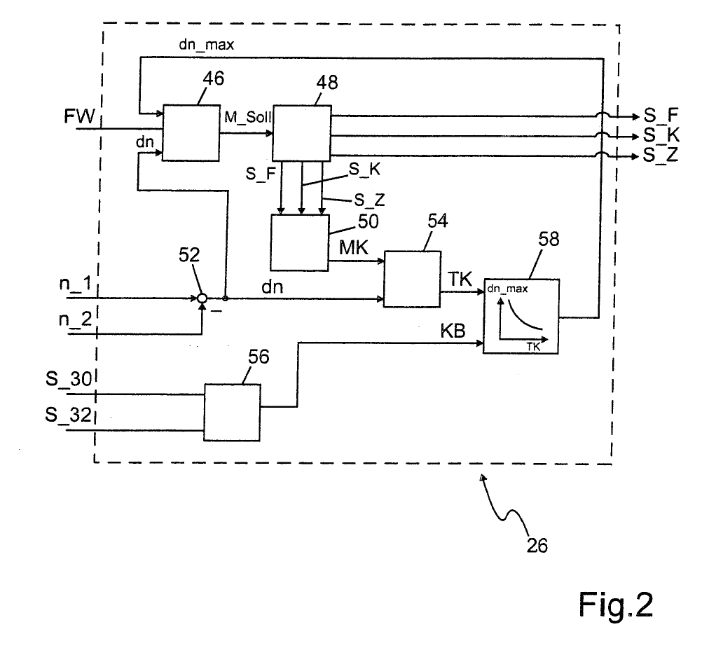

FIG. 2 shows an embodiment of the invention in the form of a block diagram of the control unit 26. Here, the individual blocks can be assigned both individual method steps and also functional modules of the control unit 26, so that FIG. 2 discloses both method aspects and also device aspects.

In detail, block 46 represents the formation of a nominal value M_Soll for the torque of the internal combustion engine 12 as a function of a driver demand FW and/or as a function of demands which are formed in the control unit 26 for controlling the internal combustion engine 12. Demands of this type result for example from a rotational speed limitation in which the torque of the internal combustion engine 12 is reduced on demand in order to prevent the exceedance of a maximum permissible rotational speed of the internal combustion engine 12.

The nominal value M_Soll which is formed in block 46 is passed to a block 48 which, from the nominal value M_Soll, forms the actuating variables S_F and/or S_K and/or S_Z, with which the subsystems 40 and/or 42 and/or 44 from FIG. 1 are activated in such a way that the internal combustion engine 12 generates the demanded torque M_Soll. In the embodiment of FIG. 2, the actuating variables S_F and/or S_K and/or S_Z are passed in parallel to an internal block 50 of the control unit 26 which represents the calculation, which was mentioned in the introduction as being known, of the clutch torque MK from operating parameters of the internal combustion engine 12. It is self-evident that further operating parameters of the internal combustion engine 12 can also be processed alternatively or in addition to the specified actuating variables.

Parallel to the calculation of the clutch torque MK in block 50, the formation of a rotational speed difference dn from the clutch input rotational speed n_1 and the clutch output rotational speed n_2 takes place in a summing junction 52. In the block 50, the temperature TK of the clutch 14 is formed by a mathematical model from operating parameters of the drivetrain 10. In one preferred embodiment, the operating parameters include at least values of the clutch torque MK and of the rotational speed difference dn across the clutch 14. Here, in one embodiment, the mathematical model takes into consideration a measured and/or modeled temperature of the internal combustion engine 12 and/or of the variable-speed transmission 16 as a base value. In addition, the mathematical model takes into consideration the friction heat which results from the product of the torque MK and the rotational speed difference dn.

The integral of the product is, as is known, proportional to the friction work done, which generally co-determines, together with empirically ascertainable values such as the heat capacity of the clutch 14 and the heat dissipation from the clutch 14, the clutch temperature TK. Values of the heat capacity and values and/or relationships for describing the heat dissipation are stored in the control unit 26, or in the block 50. It is however self-evident that the clutch temperature TK can alternatively or additionally also be determined by a temperature sensor at the clutch 14. Parallel to the determination of the clutch temperature TK, in the block 56, it is determined by evaluating the signals S_30 and S_32 as to whether the driver is actuating the clutch pedal 24. The function therefore acts as a temperature-dependent rotational speed limitation.

In the event of an actuation of the clutch pedal 24, block 56 outputs a signal KB. In this case, a block 58 is addressed with the value TK of the clutch temperature from the block 54, in which block 58 are stored predetermined limit values dn_max for the rotational speed difference dn across the clutch 14 as a function of the clutch temperature TK. The function is preferably stored in the block 58 as a characteristic curve which falls monotonously with increasing values of clutch temperature TK. The higher the value of the clutch temperature TK, the lower the fall of the limit value dn_max.

The value dn_max, which is formed in the block 58, for the maximum rotational speed difference dn across the clutch 14 is passed to the block 46 in which the nominal value M_Soll for the torque of the internal combustion engine 12 is formed. In parallel, the rotational speed difference dn which is formed in the summing junction 52 is also passed to the block 46. In order to protect the clutch, the block 46 reduces the nominal value M_Soll for the torque when the rotational speed difference dn approaches and/or reaches and/or exceeds impermissibly high values dn_max.

As a result, the permitted rotational speed difference across the clutch is in this way restricted as a function of the clutch temperature. Since the mechanical power which is converted in the clutch to heat is proportional to the rotational speed difference and the torque acting at the clutch, the restriction of the rotational speed difference according to the invention brings about a restriction of the heat output without varying the torque/rotational-speed relationship with which the driver is familiar.

At a rotational speed which can be perceived audibly or visually by a rotational speed gauge, and in the event a simultaneous demand of full torque by the driver, the torque which is associated with the rotational speed by the torque/rotational-speed characteristic curve of the internal combustion engine is also actually provided. Only if the rotational speed difference exceeds the limit value is the torque which is provided by the internal combustion engine restricted by limiting the engine rotational speed. The function therefore acts as a variable rotational speed limitation. This is clear in the case of a situation which is considered once without the invention and once with the invention.

If the driver allows the clutch to slip while demanding full torque without the invention, the rotational speed of the internal combustion engine and therefore also the rotational speed slip across the clutch could rise sharply at high torque values. As a result, a corresponding amount of friction heat would be released in the clutch, which could overheat the latter under unfavorable conditions.

Within the context of the invention, the rotational speed rise is in contrast limited if a thermal overload of the clutch is impending. The limitation is perceived directly by the driver. By means of the lack of rotational speed rise, the vehicle immediately signals to him that it cannot presently provide the demanded power.

A friction clutch 14 whose force-fitting action is controlled by a driver of the motor vehicle by a pedal 24 or manually is effectively protected from a thermal overload in this way as a result.

In addition, a further embodiment provides that a permanent slip when the clutch is not actuated is limited. For this purpose, the rotational speed difference dn when the clutch 14 is not actuated can be evaluated in the block 46. When the clutch 14 is not actuated, and therefore normally closed, the rotational speed difference across the clutch 14 should be equal to 0. If the rotational speed difference under these conditions deviates significantly from the value zero, this indicates impermissible slip. In this case, the torque of the internal combustion engine is preferably limited, with the limitation preferably taking place independently of a temperature of the clutch.

1. A method for controlling an internal combustion engine in a drivetrain of a motor vehicle, the drivetrain further having a variable-speed transmission and a friction clutch for actuation by a driver, which comprises the steps of:
controlling a force-fitting action between the internal combustion engine and the variable-speed transmission using the friction clutch;
reducing a clutch torque of the internal combustion engine for protecting the friction clutch from thermal overloading;
determining a temperature of the friction clutch;
determining a limit value, being dependent on the temperature, of a rotational speed difference across the friction clutch; and
reducing the clutch torque if the rotational speed difference one of approaches, reaches and exceeds the limit value.

2. The method according to claim 1, which further comprises determining the temperature of the friction clutch using a mathematical model from operating parameters of the drivetrain.

3. The method according to claim 2, which further comprises including as the operating parameters at least values of the clutch torque and of the rotational speed difference across the friction clutch.

4. The method according to claim 1, which further comprises monitoring as to whether the friction clutch is actuated, and carrying out the method only if the friction clutch is actuated.

5. The method according to claim 4, which further comprises limiting a permanent slip when the friction clutch is not actuated.

6. The method according to claim 1, which further comprises determining the rotational speed difference from rotational speed values of an engine rotational speed sensor and of a transmission rotational speed sensor.

7. The method according to claim 1, which further comprises determining the rotational speed difference from rotational speed values of an engine rotational speed sensor and of a wheel rotational speed sensor of the motor vehicle.

8. The method according to claim 6, which further comprises determining the rotational speed difference with further input from a wheel rotational speed sensor of the motor vehicle.

9. A control unit for controlling an internal combustion engine in a drivetrain of a motor vehicle, the drivetrain further having a variable-speed transmission and a friction clutch actuated by the driver, by use of the friction clutch a force-fitting action between the internal combustion engine and the variable-speed transmission is controlled, the control unit comprising:
the control unit being programmed to:
reduce a clutch torque of the internal combustion engine for protecting the clutch from thermal overloading;
determine a temperature of the friction clutch;
determine a limit value, which is dependent on the temperature determined, of a rotational speed difference across the clutch; and
reduce the clutch torque if the rotational speed difference one of approaches, reaches and exceeds the limit value.

10. The control unit according to claim 9, wherein the control unit is further programmed to determine the temperature of the friction clutch using a mathematical model from operating parameters of the drivetrain.

11. The control unit according to claim 10, wherein the operating parameters include at least values of the clutch torque and of the rotational speed difference across the friction clutch.

12. The control unit according to claim 9, wherein the control unit is further programmed to monitor as to whether the friction clutch is actuated, and to carry out the programmed steps only if the friction clutch is actuated.

13. The control unit according to claim 12, wherein the control unit is further programmed to limit a permanent slip when the friction clutch is not actuated.

14. The control unit according to claim 9, wherein the control unit is further programmed to determine the rotational speed difference from rotational speed values of an engine rotational speed sensor and of a transmission rotational speed sensor.

15. The control unit according to claim 9, wherein the control unit is further programmed to determine the rotational speed difference from rotational speed values of an engine rotational speed sensor and of a wheel rotational speed sensor of the motor vehicle.

16. The control unit according to claim 15, wherein the control unit is further programmed to determine the rotational speed difference with further input from a wheel rotational speed sensor of the motor vehicle.
